(19) United States
(12) Patent Application Publication
(10) Pub. No.: US 2004/0215578 A1
(43) Pub. Date: Oct. 28, 2004

(54) Controlling usage of system resources by a network manager

(75) Inventor: Debashis Das, Billerica, MA (US)

Correspondence Address: BANNER & WITCOFF, 1001 G STREET N W, SUITE 1100, WASHINGTON, DC, 20001, US

(73) Assignee: Nokia, Inc., Irving, TX

(21) Appl. No.: 10/409,939

(22) Filed: Apr. 9, 2003

(51) Int. Cl. H04L 9/00; G06F 15/16

(52) U.S. Cl. 705/77; 709/229

(57) ABSTRACT

The aspects of the present invention manage an allocation of resources for network devices in a networked system. With an aspect of the invention, a usage of a resource is gauged by a number of tokens that are associated with an action for a designated network device. The action is assigned at least one thread, where a thread corresponds to a process that supports the action. As requested, processes are initiated when an available number of tokens in a token pool can support the action. A request is stored in a request queue if a required number of tokens or threads are not available. The associated action for the designated network device is subsequently initiated when the required number of tokens and threads are available. When an action for a device completes, the assigned tokens and threads are released for reassignment in order to initiate an action for another device.

### FIELD OF THE INVENTION

The present invention relates to managing resources in a networked system for executing tasks with a plurality of network devices.

### BACKGROUND OF THE INVENTION

The growth of the Internet and other networks has encouraged many businesses to connect multiple facilities to exchange data. These facilities are often quite numerous, and may be dispersed across large geographic areas. In turn, this typically requires installation and maintenance of software for numerous gateways, routers, switches and other network control devices (nodes) to route and/or control transmission of data among the various facilities. These remote devices may also perform important security functions. As one example, some devices may act as firewalls to prevent unauthorized access to a business' computer network. Other devices may also (or alternatively) provide a Virtual Private Network (VPN) between facilities so as to prevent unauthorized access to communications between facilities. Some devices may act as proxy servers and provide access to the network, to the Internet, and to other networks for multiple individual workstations. Some devices may be configured to limit the types of network access available to a particular workstation or group of workstations. Numerous routing, access control, security and other functions may also be performed.

Operation of the network is typically dynamic, requiring software installation, software updates, backups, file uploads, and software configurations. Operation of each network device is typically governed by operating system and application software that is stored on and executed by the device. Installed software (e.g. operating systems and applications) at each of the remote network devices typically has a large number of configurable parameters that must be set to specific values for desired operation of the network device. Consequently, configuring each remote device may require significant system resources such as network bandwidth and processing resources of a management station. As the number of remote devices increase, the demands on network bandwidth and processing resources increase and the potential for adverse effects is exacerbated. Moreover, different types of tasks (processes), e.g., operating system installation and software inventory, may have different demands on system resources. If too many remote devices are vying for the same system resources at the same time, network performance may experience adverse effects if the demands are not scheduled within the constraints of the system resources.

The market tendency is for networks to become larger with more remote network devices (nodes) that are managed from a system management facility such as a management station. Also, installed software that resides at remote network devices is typically becoming more complex, thus increasing the demands on system resources. Moreover, associated tasks (e.g. software inventory, software installation, software configuration, backups and file uploads) impose different demands on the system resources. Thus, there is a real need to provide apparatus and method that control the allocation of the network resources to tasks associated with the different network devices in order to manage system resources while effectively utilizing the resources.

### SUMMARY OF THE INVENTION

The aspects of the present invention manage an allocation of resources for network devices in a networked system. With an aspect of the invention, a usage of a resource is gauged by a number of tokens that are associated with an action for a designated network device. The action is assigned at least one thread, where a thread corresponds to a process that supports the action. As requested, processes are initiated when an available number of tokens in a token pool can support the action. With an aspect of the invention, a request is stored in a request queue if a required number of tokens or threads are not available. The associated action for the designated network device is subsequently initiated when the required number of tokens and threads are available. With another aspect of the invention, when an action for a device completes, the assigned tokens and threads are released for reassignment in order to initiate an action for another network device.

In a first exemplary embodiment of the invention, a network manager initiates actions for designated network devices in a sequential manner. A first action is initiated for at least one network device until either an available number of tokens in the token pool or the number of threads is insufficient to support the first action. When all the network devices have completed the first action, a second action may be initiated for another group of designated network devices.

In a second exemplary embodiment of the invention, a network manager can concurrently support a plurality of actions for network devices. A token pool and a thread pool may be partitioned for different actions so that the number of tokens and number of threads in each set of partitions reflect a usage intensity for a corresponding action.

### BRIEF DESCRIPTION OF THE DRAWINGS

FIG. 1 is a block diagram of a system architecture and a collection of network control devices in which the present invention may be implemented;

FIG. 2 shows a computing architecture that supports multithreading with a multithreaded processor in which the present invention may be implemented;

FIG. 3 shows a computing architecture that supports multithreading with symmetric multiprocessing (SMP) in which the present invention may be implemented;

FIG. 4 shows a flow diagram for sequentially performing tasks for different network devices in accordance with an embodiment of the invention;

FIG. 5 shows a flow diagram for concurrently performing tasks for different network devices in accordance with an embodiment of the invention;

FIG. 6 is a continuation of the flow diagram that is shown in FIG. 5;

FIG. 7 is a functional architecture on which processes may be executed in accordance with embodiments of the invention; and

FIG. 8 shows a screen view of command entries for performing tasks by a network manager.

### DETAILED DESCRIPTION OF THE INVENTION

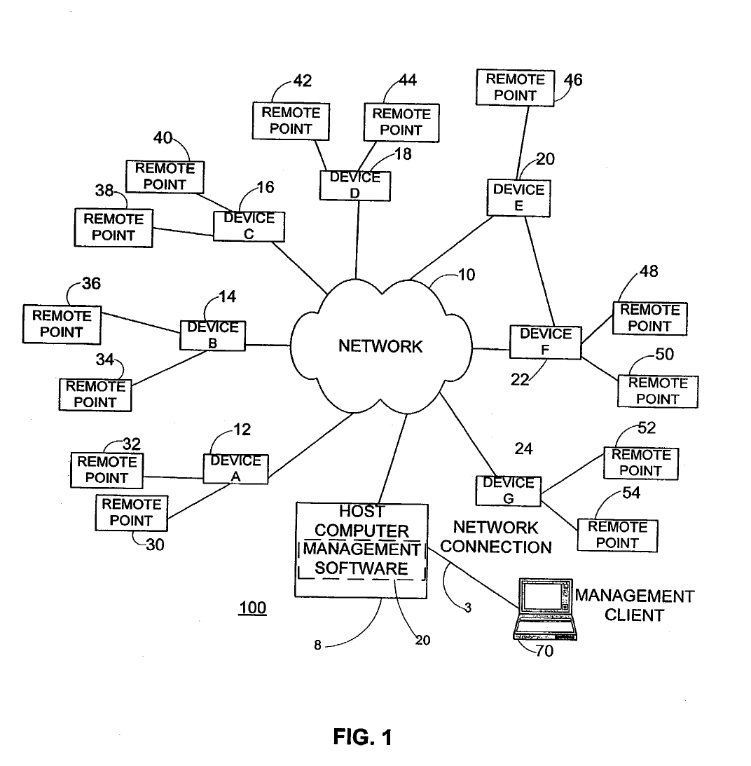

FIG. 1 is a block diagram showing a system architecture supporting multiple network control devices that are distributed throughout a data communication system 100. A network 10 may be the Internet, an Intranet, one or more interconnected Wide Area Networks and/or Local Area Networks, or any other data communication network. Connected to and communicating through network 10 are numerous network control devices 12-24. Devices 12-24 may be firewalls, gateways, routers, switches, bridges, proxy servers or other devices. A number of remote points 30-54 communicate through each device 12-24. Remote points 30-54 may be client computers in communication with one or more central hosts or with other clients, sales terminals or other computers having a more limited functionality, database or other servers, or any other component or collection of components capable of data communication. Some devices 12-24 may connect remote points 30-54 through network 10 with other devices and other points within the network, while some devices 12-24 may connect directly to other devices.

FIG. 1 also shows a host computer 8 that operates as a network manager. Host computer 8 communicates with devices 12-24, and contains management software 20 for monitoring and/or otherwise controlling devices 12-24. Host computer 8 may further monitor and/or control other aspects of system 100. Host 8 may perform other functions in addition to management of devices 12-24, and indeed may perform functions unrelated to network management. There may be multiple host computers 8 within a system 100, and the management functions of host 8 may be distributed across multiple computers. A management client 70, which may be a separate computer workstation, accesses host computer 8. As one example, management client 70 may represent a portable or desktop computer used by a network administrator to log onto host computer 8 via a local area network connection 3. Alternatively, management client 70 may be more distant from the host 8 (e.g., operating as one of the remote points 30-54). Management client 50 and host computer 8 might also be combined into a single computer.

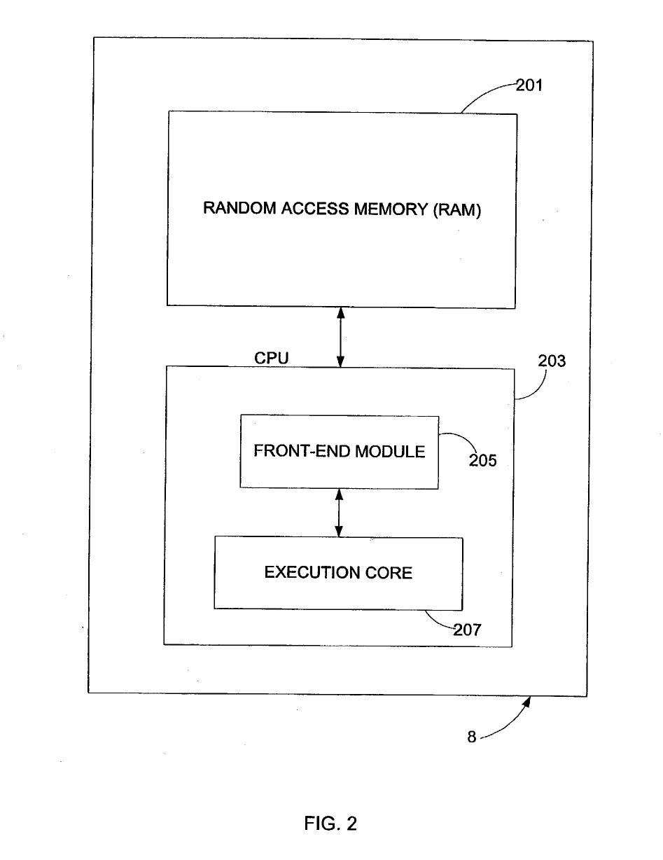

FIG. 2 shows a computing architecture that supports multithreading with a multithreaded processor 203 in which the present invention may be implemented. Network manager 8 (as shown in FIG. 1) comprises a random access memory (RAM) 201 and processor (CPU) 203. In turn, processor 203 comprises a front-end module 205 and an execution core 207. Processor 203 may execute more than one thread at a time, where each tread corresponds to a process. In the embodiment, random access memory 201 stores a plurality of processes, in which each process is associated with a context. A thread is a part of a process (that may be referred as a program) that executes independently of other parts. Operating systems that support multithreading enable programmers to design programs whose threaded parts can execute concurrently. A context encompasses all the information that describes a process's current state of execution, e.g., the contents of the CPU registers, program counter, and flags.

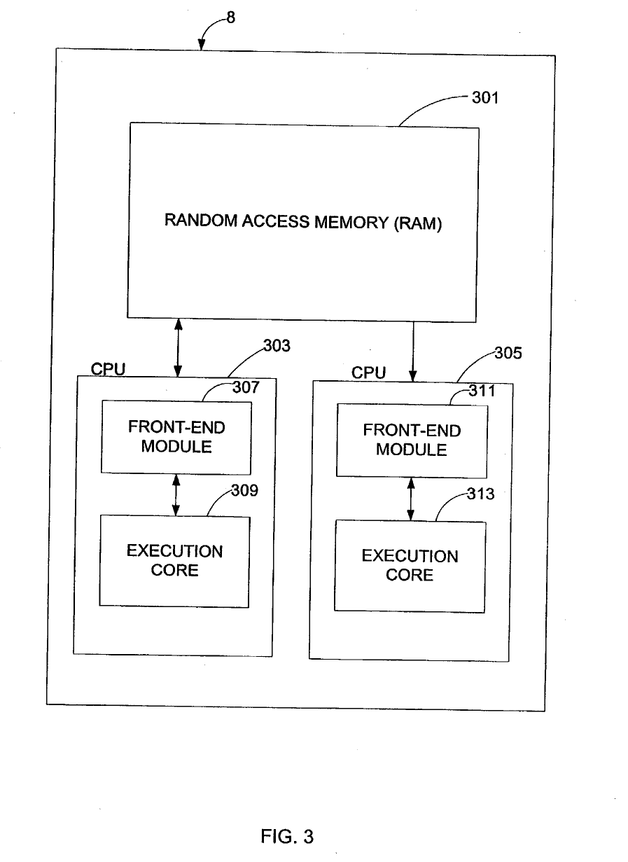

A process is associated with at least one thread, where a thread is executed to support the process. The execution of threads may be controlled by an operating system (OS) running on network manager 8. Even though threads may be bundled together into a process, threads may have a degree of independence from each other. For example, processes may execute on different processors (e.g. CPU 303 and CPU 305 as shown in FIG. 3). Moreover, threads that are associated with a same process may execute on different processors.

Referring to FIG. 2, front-end module 205 provides a plurality of instructions from random access memory 201 for each clock cycle and sends the instructions to execution core 207 for execution. In the embodiment, each of the plurality of the instructions during the clock cycle is associated with the same thread. (In variations of the embodiment, front-end module 205 may issue instructions that are not associated with the same thread during a clock cycle.) Each executing thread is confined to the clock cycle, where another thread may be executed in the next clock cycle. In such a case, a clock cycle may be referred as a “time slice.” With variations of the embodiment, a time slice may comprise a plurality of clock cycles. Front-end module 205 may switch back and forth between threads as instructions are sent to execution core 207 in order to better utilize processing resources of execution core 207.

FIG. 3 shows a computing architecture that supports multithreading with symmetric multiprocessing (SMP) in which the present invention may be implemented. Network manager 8 comprises a random access memory 301 and processors (CPUs) 303 and 305. In turn, processor 303 comprises a front-end module 307 and an execution core 309, and processor 305 comprises a front-end module 311 and an execution core 313. As with random access memory 201, random access memory 301 stores a plurality of processes, in which each process is associated with a context. The operating system running on network manager 8 may schedule two processes (threads) for execution at the same time (i.e. during the same time slice), with one thread being executed by execution core 309 and the other thread being executed by execution core 313. Front-end module 307 and front-end module 311 issues instructions to execution core 309 and execution core 313, respectively.

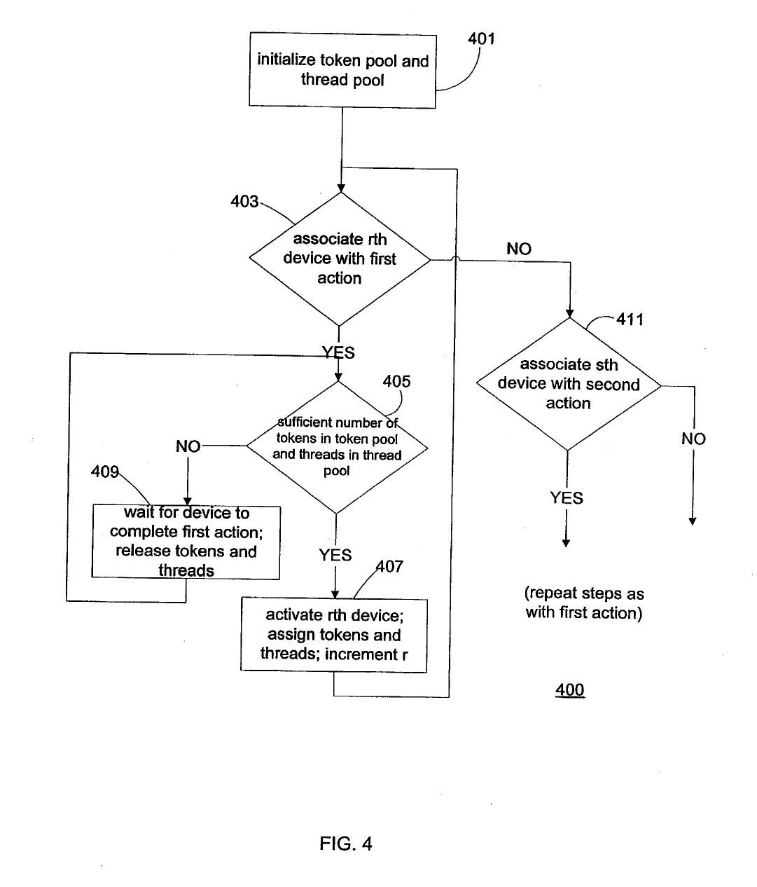

FIG. 4 shows a flow diagram 400 for sequentially performing tasks (processes) by network manager 8 for different network devices (nodes), e.g., network devices 12-24 as shown in FIG. 1, in accordance with an embodiment of the invention. As an example, a first process may be associated with downloading an application file to network device 12, a second process may be associated with downloading the application file to network device 14, and a third process may be associated with uploading a file from network device 16. In this example, a first action is associated with downloading the application file (to network devices 12 and 14) and a second action is associated with uploading the file (to network 16). (An action may be associated with different activities including a software installation, a password update, a software configuration, a restoration of device configurations, a file upload, and a file backup.)

In step 401, a token pool and a thread pool are initialized. A number of tokens are associated with an action in order to gauge a portion of a system resource that is necessary to support the action. As an example of the embodiment, network manager 8 may assign a weight (e.g. a weight from 1 to 5, where a weight of 1 corresponds to a low cost operation) to an execution of an action for a network device. Each weight corresponds to a number of tokens. For example, a weight of 1 may correspond to 1 token and a weight of 5 may correspond to 5 tokens. However, variations of the embodiment may utilize a different weight-to-token mapping. A password update procedure may be assigned 1 token, while a resource-intensive activity (e.g. an operating system installation) may be assigned 5 tokens. A token pool may be initialized with 100 tokens. Tokens are taken from the token pool and assigned when an activity is initialized for a network device. The tokens are returned to the token pool when the activity has been completed for the network device.

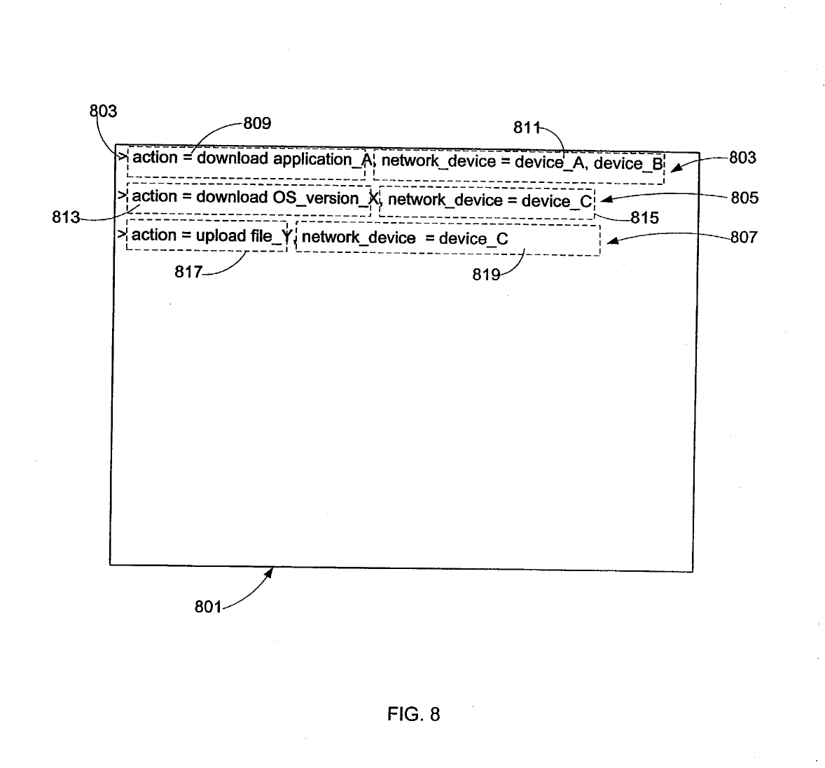

A system resource may correspond to different resources such as a network bandwidth allocation in a forward direction (i.e. from network manager 8 to a network device through network 10) and an associated usage of processing resources of network manager 8. In step 403, in response to a request, the action is associated with one of the requested network devices (designated as the r^{th} device in flow diagram 400). As discussed in the context of FIG. 8, an action may be requested for one or more network devices. For example, in FIG. 8, an action corresponding to downloading application A is associated with network device A (shown as device 12 in FIG. 1) and network device B (device 14).

Associating the action to each device requires a portion of system resources, which is gauged by a required number of tokens. For example downloading a large file typically requires a greater network bandwidth than downloading a small file. In step 405, network manager 8 determines whether a sufficient number of tokens are available in the token pool and a thread is available in the thread pool for activating a process for the action and designated device. (In the embodiment, a process utilizes one thread, although in other embodiments a process may utilize multiple threads.) If a sufficient number of tokens or threads are not available, in step 409 network manager 8 waits for a previously assigned device to complete the action so that the assigned tokens and threads can be released and reassigned to the device in order to execute the action. However, if a sufficient number of tokens and threads are available, the tokens and thread are assigned and the action is activated for the device in step 407. Steps 403-409 are repeated until the action has been activated for all the designated devices. In step 411 and subsequent steps, process 400 activates another action to another group of designated devices. The other group of devices may contain some or all of the devices that are contained in the previous group of devices.

With a variation of the embodiment, the token pool and/or the thread pool may be adjusted in size by manager 8 in order to enhance a utilization of an associated processor (e.g. CPU 203 as shown in FIG. 2).

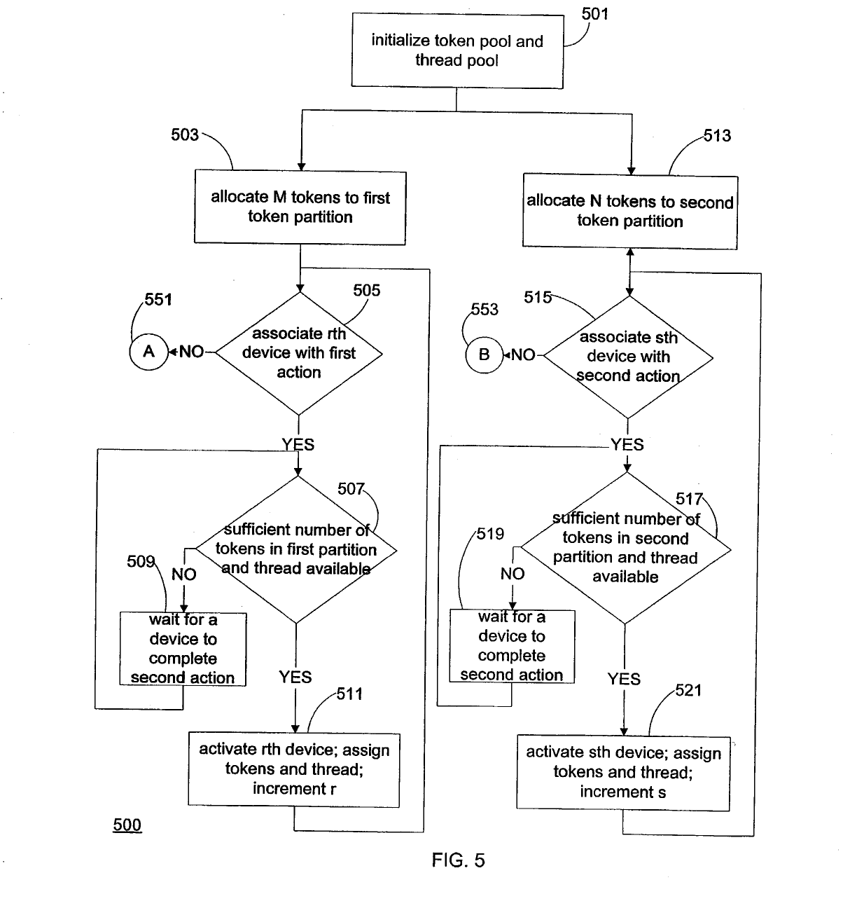

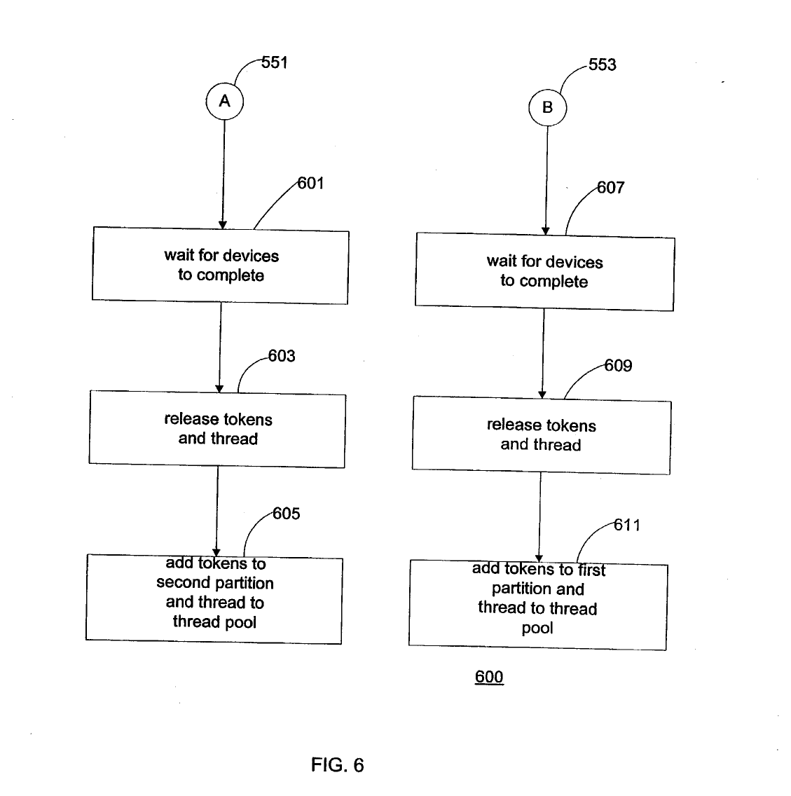

FIG. 5 shows a flow diagram 500 for concurrently performing tasks (processes) for different network devices in accordance with an embodiment of the invention. In the embodiment shown in flow diagram 500, different actions may be executed during the same time interval. (In the embodiment shown in flow diagram 400, a previous action is completed before activating a subsequent action.) In process 500 and process 600 (which is a continuation of process 500 and is shown in FIG. 6), steps 503-511 and steps 601-605 are concurrently executed with steps 513-521 and steps 607-611.

In steps 503 and 513, the token pool may be partitioned into token partitions that correspond to different actions. (For example, as shown in FIG. 8, command line 803 may be executed during the same time duration as command line 805.) Moreover, the thread pool may be partitioned for each action. However, in a variation of the embodiment, the token pool may be shared by a plurality of actions. The token partitions are sized in accordance with intensity of resource utilization by each action. For example, an action corresponding to downloading a version of an operating system may be more resource intensive than performing a software inventory of a network device.

During steps 503-511 and steps 601-605, a first action is activated for designated devices (designated as the r^{th} device in flow diagram 500), while during steps 513-521 and steps 607-611 a second action is activated for another group of designated devices (designated as the s^{th} device). As an example as shown in FIG. 8, command line 803 corresponds to activating a first action for downloading application_A for network device A and network device B (as executed by steps 503-511 and steps 601-605), and command line 805 corresponds to activating a second action for downloading OS_version_X to network device C (as executed by steps 513-521 and steps 607-611). In the embodiment, a plurality of actions may be activated for a network device if the network device is capable of concurrent actions.

FIG. 6 is a flow diagram 600 and is a continuation of flow diagram 500 that is shown in FIG. 5. In step 601 network devices complete the first action and release the assigned tokens and threads in step 603. Consequently, assigned tokens are released to the second token partition if the second action is pending for any network devices in step 605. Similarly, assigned tokens and threads are released and reallocated for the first action in steps 607-611 when network devices complete the second action.

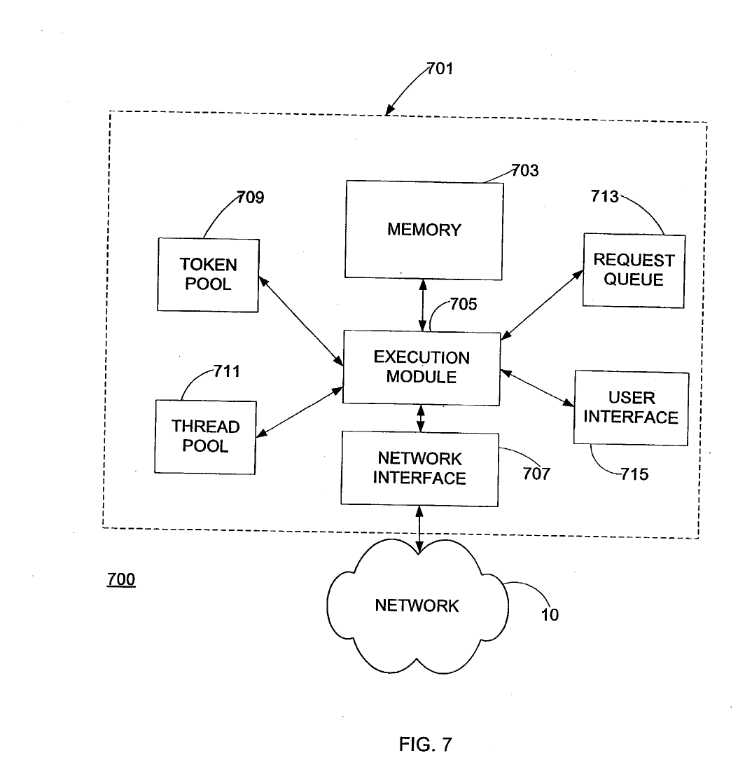

FIG. 7 is a functional architecture 700 on which processes may be executed in accordance with embodiments of the invention. A functional architecture 701 corresponds to network manager 8. Functional architecture 701 comprises a memory 703, an execution module 705, a network interface 707, a token pool 709, a thread pool 711, a request queue 713, and a user interface 715. Functional architecture 701 represents a logical functionality of network manager 8. Memory 703 stores processes and may also store other software entities, including files for applications that are executed on network devices, versions of operating systems that are downloaded to network devices, and upload files from network devices. Execution module 705 executes threads for processes in order to perform actions for designated network devices. Execution module 705 may correspond to one processor or a plurality of processors. Also, execution module receives commands from a user through user interface 715 (corresponding to management client 70 in FIG. 1). If the associated request cannot be executed by execution module 705, the request is queued in request queue 713 until a sufficient number of tokens and threads are available for initiating the action for the designated network devices in accordance with the command. In a variation of the embodiment, the request may be rejected if a sufficient number of tokens and threads are not available. In such a case, the request may be re-entered through user interface 715.

Token pool 709 stores tokens that gauge a usage of a network resource. Token pool 709 typically comprises memory and may be physically associated with memory 703. Thread pool 711 stores threads and associated contexts and also may be physically associated with memory 703.

Execution module 705 communicates to network devices through network 10 and network interface 707. Communications through network 10 may be either in a forward direction (i.e. in a direction from network manager 8 to a network device) or in a reverse direction (i.e. in a direction from a network device to network manager 8). Consequently, a system resource may be separately associated either for the forward or the reverse direction (e.g. allocated network bandwidth).

FIG. 8 shows a screen view 801 of command entries for performing tasks by network manager 8. Screen view 801 is visible to a user through a monitor that is associated with management client 70 as shown in FIG. 1. A command line 803 comprises a prompt 803 (“>”), an action field 809, and a device field 811. Action field 809 designates the action (downloading application_A), while device field 811 specifies the designated network devices for which the action will be initiated. A command line 805 comprises an action field 813 (downloading OS_version X) and a device field 815 (network device C). A command line 807 comprises an action field 817 (uploading file_Y from a network device) and a device field 819 (network device C).

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. Typographical ordering of elements within the appended claims shall not be construed as a logical ordering of the elements unless otherwise stated.

I claim:

1. A method for controlling a system resource, the method comprising:
(a) receiving a first request to initiate a first action for a first network device;
(b) determining a first required number of tokens that is necessary to execute the first action, wherein the first required number of tokens corresponds to a first usage of the system resource that is allocated to execute the first action;
(c) determining an available number of tokens remaining in a token pool;
(d) if the available number of tokens is as great as the first required number of tokens, initiating the first action for the first network device; and
(e) in response to (d), reducing the available number of tokens by the first number of tokens.

2. The method of claim 1, wherein (b) comprises:
(i) assigning a first weight to the first action; and
(ii) mapping the first weight to the first required number of tokens.

3. The method of claim 1, wherein performing (d) further requires that at least one thread is available from a thread pool, the method further comprising:
(f) assigning a first thread from the thread pool to execute the first action.

4. The method of claim 3, further comprising:
(g) when the first action has been completed for the first network device, relinquishing the first required number of tokens to the token pool and relinquishing the first thread to the thread pool; and
(h) in response to (f), increasing the available number of tokens by the first required number of tokens.

5. The method of claim 1, further comprising:
(f) queuing a second request to initiate the first action for a second network device until the available number of tokens is as great as the first required number of tokens.

6. The method of claim 1, further comprising:
(f) denying a second request to initiate the first action for a second network device.

7. The method of claim 6, wherein the available number of tokens is less than the first required number of tokens.

8. The method of claim 1, further comprising:
(f) receiving a second request to initiate a second action for a second network device;
(g) determining a second required number of tokens that is necessary to execute the second action, wherein the second required number of tokens corresponds to a second usage of the system resource that is allocated to execute the second action;
(h) determining the available number of tokens remaining in the token pool;
(i) if the available number of tokens is as great as the second required number of tokens, initiating the second action for the second network device; and
(j) in response to (i), reducing the available number of tokens by the second required number of tokens.

9. The method of claim 1, wherein (g) comprises:
(i) assigning a second weight to the second action; and
(ii) mapping the second weight to the second required number of tokens.

10. The method of claim 8, wherein the first action completes before executing the second action.

11. The method of claim 1, further comprising:
(f) separating a total number of tokens into a first token partition and a second token partition, wherein the first token partition is associated with the first action and the second token partition is associated with a second action.

12. The method of claim 1, further comprising:
(f) separating a plurality of threads into a first thread partition and a second thread partition, wherein the first thread partition is associated with the first action and the second thread partition is associated with a second action.

13. The method of claim 1, wherein the first action is selected from the group consisting of a software installation, a password update, a software configuration, a restoration of device configurations, a file upload, and a file backup.

14. The method of claim 1, wherein the system resource is selected from the group consisting of a network bandwidth allocation and a usage of processing resources.

15. The method of claim 14, wherein the network bandwidth allocation is associated with a forward direction from a management station to a network device.

16. The method of claim 14, wherein the network bandwidth allocation is associated with a reverse direction from a network device to a management station.

17. The method of claim 1, further comprising:
(f) adjusting a number of threads in the thread pool in order to enhance a utilization of an execution module, wherein the execution module comprises at least one central processing unit (CPU).

18. A computer-readable medium having computer-executable instructions for performing the method recited in claim 1.

19. A computer-readable medium having computer-executable instructions for performing the method recited in claim 4.

20. A computer-readable medium having computer-executable instructions for performing the method recited in claim 5.

21. A manager that controls usage of a resource of a networked system, the manager comprising:
a token pool that contains a plurality of tokens, wherein each token gauges a utilization of the resource;
a thread pool that contains a plurality of threads, wherein each thread of the thread pool corresponds to a process; and
an execution module that receives a first request to initiate a first process, determines a required number of tokens that are associated with the first request, and if the token pool contains at least the required number of tokens and if one of the plurality of threads is available, assigns a thread to the first process in accordance with program instructions, wherein the first process is associated with a first action for a first network device.

22. The manager of claim 21, further comprising a queuing module that stores the first request for later execution by the execution module if the token pool contains less than the number of tokens or if no threads are available from the thread pool.

23. The manager of claim 21, further comprising a queuing module that stores a second request for later execution by the execution module if the token pool contains less than a number of tokens or if no threads are available from the thread pool, wherein the second request initiates a second process and wherein the second process is associated with a second action for a second network device.

24. The manager of claim 21, further comprising a user interface, wherein a user enters a command corresponding to at least one request and wherein the at least one request initiates at least one process.

25. The manager of claim 24, wherein the command comprises a first identification that signifies a designated action from a plurality of actions and a second identification that signifies at least one network device, wherein the command initiates the designated action for the at least one network device.

26. The manager of claim 21, further comprising a memory that stores a management application, wherein the management application provides the program instructions for the execution module.

27. The manager of claim 26, wherein the memory further stores a software entity that is selected from the group consisting of a user application, a version of an operating system, an uploaded file from a network device, a backup file, a restoration file, and a configuration file.

28. The manager of claim 21, wherein the execution module comprises at least one processor and wherein the at least one processor executes at least one process.

29. A method for controlling bandwidth network usage by a management application, the method comprising:
(a) receiving a request to initiate a first network device and a second network device;
(b) determining a required number of tokens that is necessary to run the action;
(c) determining an available number of tokens remaining in a token pool;
(d) if the available number of tokens is as great as the required number of tokens and if at least one thread is available from the thread pool, assigning a first thread and initiating the action for the first network device, and reducing the available number of tokens by the required number of tokens;
(e) when the action has been completed for the first network device, relinquishing the required number of tokens to the token pool, relinquishing the first thread to the thread pool, and increasing the available number of tokens by the required number of tokens;
(f) if the available number of token is less than the required number of tokens, queuing the request to initiate the action for a second network device until the available number of tokens is as great as the required number of tokens; and
(g) if the available number of tokens is as great as the required number of tokens and if the at least one thread is available from the thread pool, assigning a second thread and initiating the action for the second network device.
